(19) United States
(12) Patent Application Publication
(10) Pub. No.: US 2012/0069056 A1
(43) Pub. Date: Mar. 22, 2012

(54) INFORMATION DISPLAY APPARATUS AND INFORMATION DISPLAY PROGRAM

(75) Inventor: Masahiro ITO, Tokyo (JP)

(73) Assignee: YAPPA CORPORATION, Tokyo (JP)

(21) Appl. No.: 13/235,252

(22) Filed: Sep. 16, 2011

(30) Foreign Application Priority Data
Sep. 17, 2010 (JP) 2010-209014

(51) Int. Cl. G09G 5/00; G06F 3/041

(52) U.S. Cl. 345/684; 345/173

(57) ABSTRACT

An information display apparatus is provided capable of performing display control based on a plurality of touch inputs from a multi-touch input panel. The information display apparatus comprises: a contact-point acquisition section for acquiring a contact point on the multi-touch input panel; a multi-touch determination section for determining whether the contact point acquired by the contact-point acquisition section is a multi-touch; a touch-motion determination section for, when the contact point is determined as a multi-touch by the multi-touch determination section, determining a moving motion of the contact point; a page-number setting section for calculating and setting a turning-page number for a multi-page turning processing, based on the moving motion determined by the touch-motion determination section; and a page turning processing section for performing a page turning processing based on the turning-page number determined by the page-number setting section.

### TECHNICAL FIELD

The present invention relates generally to an information display apparatus, such as an electronic book (e-book) reader, and more specifically to a graphical user interface for displaying multi-page information provided in an apparatus.

### BACKGROUND ART

It has been a long time since an e-book reader was put to practical use. The e-book reader is designed to read out information, such as text, image or audio, from a recording medium, such as a hard disk, a flash memory or a CD-ROM, and present the read-out information to a user through a display section, such as an LCD section. In terms of reading multi-page information, a user can use the e-book reader like a paper book.

In addition to the recording medium and the display section, the e-book reader further comprises an operating section which may be implementable in various forms. For example, an example of the operating section includes a light pen and a touch pen. In recent years, a touch panel integrally comprising a display section and an operating section has become a mainstream form. A user touches the touch panel on which information is displayed, with a pen or his/her finger to directly perform an operation (zoom-in (scaling-up) operation, zoom-out (scaling-down) operation, scrolling operation, rotating operation, searching, page turning (flipping), etc.) for book information.

As a device for realizing a direct operation for book information, there has been known a touch panel comprising a touch sensor.

There has also been known an interfacing technique for allowing a user to read multi-page information using a “page turning” function, as disclosed, for example, the following Patent Documents 1 and 2.

The Patent Document 1 discloses an electronic book reader and an information display apparatus, designed to allow information, such as text and image, designated, written-down and entered by a user according to need, to be managed in a simple and user-friendly manner.

Particularly, in the e-book reader disclosed in the Patent Document 1, based on a “page turning” function, a user can refer to a set-up e-book at the same level of usability as that when referring to an actual paper book. For example, when the user wants to refer to a next page, the user continuously moves his/her index finger on and along an information display area on a screen in a rightward direction, with a motion (gesture) similar to that during turning of a page of a paper book. Accordingly, the content on the display screen will be updated to that of the next page, while displaying an image indicative of page turning.

As above, according to the invention disclosed in the Patent Document 1, a user can perform a page turning input in a manner similar to that for handing a traditional paper book, so that it becomes possible to provide a human interface which is easy to learn how to operate, and excellent in usability.

The Patent Document 2 discloses an apparatus, a method and a program for position information processing, designed to interpret an instruction expressed by a combination of loci of a plurality of instruction positions which are simultaneously moved. More specifically, respective loci of a plurality of instruction positions simultaneously moved are identified by: simultaneously detecting the instruction positions using a touch panel or the like; after the instruction positions are moved, simultaneously re-detecting the instruction positions; calculating a distance between corresponding ones of the current instruction positions and the last instruction positions; and acquiring a movement locus of each of the instruction positions on an assumption that, one in the last instruction positions, the last instruction position closest to a specific one the current instruction positions is associated with to the specific current instruction position. Then, a user's instruction expressed by a combination of the loci of the instruction positions is interpreted to execute an instructed operation.

Particularly, as for the “page turning” function, as an example of control to be performed when a user's motion (gesture) is interpreted as an instruction for a page turning processing, the Patent Document 2 discloses a technique of, when there are two cases: one case where at a time t1, there are an instruction position At1 and an instruction position Bt1, i.e., a total number of the instruction positions is two; and the other case where at a time t2, there are an instruction position At2, an instruction position Bt2, an instruction position Ct2 and an instruction position Dt2, i.e., a total number of the instruction positions is four, interpreting an input at the time t2 having a larger total number of the instruction positions, as an instruction for increasing the number of pages to be turned (turning-page number) in a page turning processing.

### LIST OF PRIOR ART DOCUMENTS

### Patent Documents

Patent Document 1: JP 2000-163444A
Patent Document 2: JP 2001-290585A

### SUMMARY OF THE INVENTION

### Problem to be Solved by the Invention

However, the technique disclosed in the Patent Document 1 is incapable of turning a plurality of pages at once. Further, in the technique disclosed in the Patent Document 2, when a user wants to turn a plurality of pages, it is difficulty to simply enter an instruction for a specific number of turning pages when a user wants to turn a plurality of pages at once.

Therefore, there is a need for an information display apparatus, such as an e-book reader, which is easier to use at least in executing an operation of turning a plurality of pages at once (hereinafter referred to as “multi-page turning”).

### Means for Solving the Problem

According to a first aspect of the present invention, there is provided an information display apparatus for performing control based on a plurality of touch inputs from a multi-touch input panel. The information display apparatus comprises: a contact-point acquisition section for acquiring a contact point on the multi-touch input panel; a multi-touch determination section for determining whether the contact point acquired by the contact-point acquisition section is a multi-touch; a touch-motion determination section for, when the contact point is determined as a multi-touch by the multi-touch determination section, determining a moving motion of the contact point; a page-number setting section for calculating and setting a turning-page number for a multi-page turning processing, based on the moving motion determined by the touch-motion determination section; and a page turning processing section for performing a page turning processing based on the turning-page number determined by the page-number setting section.

In the information display apparatus of the present invention, the touch-motion determination section is operable, when it is detected that the contact-point moving motion is performed over a distance of a given value or more, to determine that the contact-point moving motion is valid.

In the information display apparatus of the present invention, the touch-motion determination section is adapted to manage a distance during the contact-point moving motion, based on a plurality of segments, and the page-number setting section is operable to calculate and set the turning-page number for the multi-page turning processing, based on a page number assigned correspondingly to each of the segments.

According to a second aspect of the present invention, there is provided an information display program executable in an information display apparatus for performing control based on a plurality of touch inputs from a multi-touch input panel. The information display program is adapted to cause the information display apparatus to perform a process comprising the steps: a contact-point acquisition step of acquiring a contact point on the multi-touch input panel; a multi-touch determination step of determining whether the contact point acquired through the contact-point acquisition step is a multi-touch; a touch-motion determination step of, when the contact point is determined as a multi-touch through the multi-touch determination step, determining a moving motion of the contact point; a page-number setting step of calculating and setting a turning-page number for a multi-page turning processing, based on the moving motion determined through the touch-motion determination step; and a page turning processing step of performing a page turning processing based on the turning-page number determined through the page-number setting step.

### Effect of the Invention

The information display apparatus of the present invention makes it possible to more simply enter an instruction for a specific number of turning pages so as to execute a page turning processing.

### BRIEF DESCRIPTION OF THE DRAWINGS

FIG. 1 is a schematic diagram illustrating an external appearance of an information display apparatus according to one embodiment of the present invention.

FIG. 2 is a block diagram illustrating a hardware configuration of the information display apparatus according to the embodiment.

FIG. 3 is a block diagram illustrating a functional configuration of the information display apparatus according to the embodiment.

FIG. 4 is a flowchart illustrating one example of steps of processing in the information display apparatus according to the embodiment.

FIG. 5 is a flowchart illustrating another example of the steps of processing in the information display apparatus according to the embodiment.

FIGS. 6(A) and 6(B) are schematic diagrams illustrating one example of a page turning motion in the information display apparatus according to the embodiment.

FIGS. 7(A) and 7(B) are schematic diagrams illustrating an example of a process of setting a turning-page number for a page turning processing, in the information display apparatus according to the embodiment.

FIGS. 8(A) to 8(C) are schematic diagrams illustrating another example of the page turning motion, in the information display apparatus according to the embodiment.

FIGS. 9(A) and 9(B) are schematic diagrams illustrating an example of a process of determining a page turning motion, in the information display apparatus according to the embodiment.

### DESCRIPTION OF EMBODIMENTS

The present invention will now be specifically described based on an embodiment thereof.

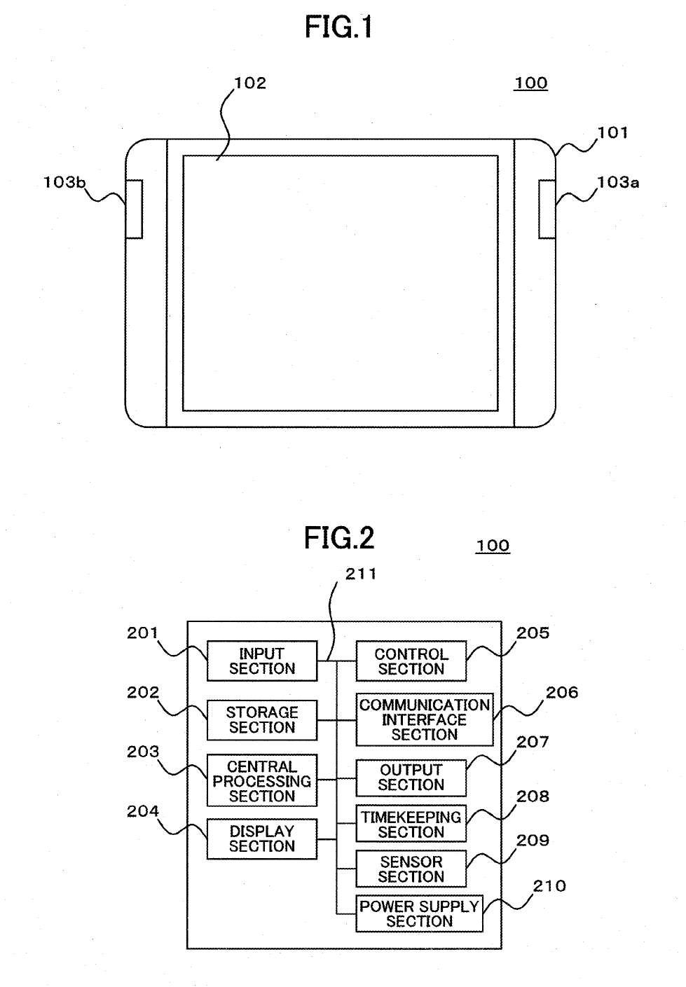

FIG. 1 illustrates an external appearance of an information display apparatus according to one embodiment of the present invention. The information display apparatus 100 comprises a housing 101, a display 102, and two hardware buttons 103a, 103b provided on left and right sides of the housing 101. The display 102 is composes, for example, of a liquid-crystal display (LCD), and adapted to display various information, such as character and image, as described later. Further, the display 102 is adapted to display a menu button or a software keyboard thereon and allow a user to touch it with his/her finger, a touch pen (not illustrated) or the like so as to enter an instruction (command) to the information display apparatus. In this regard, the hardware buttons 103a, 103b are not essential components. However, for the sake of convenience of explanation, each of the hardware buttons 103a, 103b will be described as a button adapted to carry out a certain function. It is understood that each of the hardware buttons 103a, 103b may be replaced by a menu button displayed on a part of the display 102.

The display 102 comprises a multi-touch input panel, wherein a touch-input position coordinate on the multi-touch input panel is sent to a processing section (CPU) of the information display apparatus 100 via an input device interface (not illustrated) and processed in the processing section. The multi-touch input panel is adapted to simultaneously sense a plurality of contact points with respect to the panel. This sensing (detection) can be realized by various techniques, and a sensor therefor is not limited to a contact-type sensor. For example, an optical sensor may be used to extract an instruction point with respect to the panel. As a sensor other than the contact-type sensor and the optical sensor, a capacitance type sensor operable to sense a touch of human skin may be used.

The information display apparatus 1100 may further comprise a microphone and a speaker as in various personal digital assistants, although they do not appear in FIG. 1. In this case, for example, user's voice picked up by the microphone may be discriminated and used as an input command.

FIG. 2 is a block diagram illustrating a hardware configuration of the information display device 100 according to this embodiment. An operation of the information display device 100 is realized by individual operations of and cooperative operations with the aftermentioned hardware.

The information display device 100 roughly comprises: an input section 201 including the hardware buttons 103a, 103b, the multi-touch input panel provided in the display 102, a microphone; a storage section 202 including a hard disk, a RAM and/or PAM for storing therein a program, data, etc.; a central processing section 203 composed of a CPU for performing various numerical calculations and logical operations according to a program; a display section 204 including the display 102; a control section 205 for performing various controls for a chip, an electric system, etc.; a communication interface section 206 including a slot for accessing the Internet, a port for performing optical communications, an communication interface; an output section 207 composed of a speaker, a vibrator or the like; a timekeeping section 208 for measuring clock time, etc.; a sensor section 209 for measuring temperature, humidity, posture of the apparatus, light intensity, etc., according to need; and a power supply section 210 for supplying electric power to each of a plurality of modules within the apparatus. These modules are appropriately interconnected by a communication bus or feed lines (in FIG. 2, the lines are appropriately segmented in lump and illustrated as a connection line 211).

A program or software necessary for implementing the present invention is generally installed or stored in the hard disk or the like in the storage section 202. Then, in advance of execution of the program or software, it is entirely or partially read out into a memory within the storage section 202 according to need, and executed in the CPU 203.

It is not essential to execute the program or software in the central processing section 203 such as a CPU, but an auxiliary processor, such as a digital signal processor (DSP), may also be used.

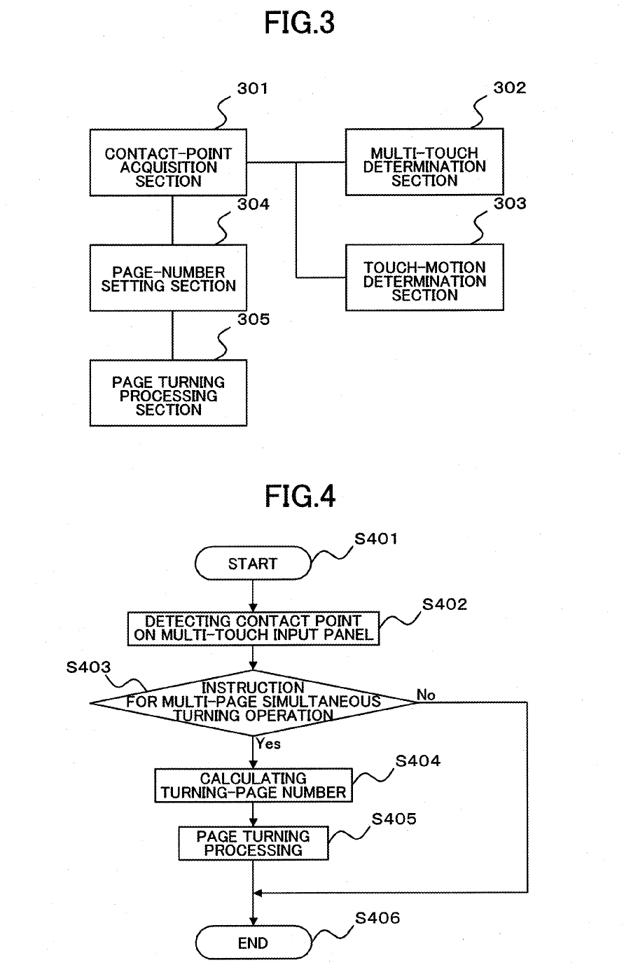

FIG. 3 is a block diagram illustrating a functional configuration of the information display apparatus according to this embodiment.

In FIG. 3, a contact-point acquisition section 301 is operable to detect a contact of a pen or a finger with respect to the multi-touch input panel and acquire the detected point as a coordinate. Further, the contact-point acquisition section 301 is operable, when the pen or finger is brought into contact with a plurality of points on the multi-touch input panel, to acquire a plurality of coordinates at respective detected points. Furthermore, the contact-point acquisition section 301 is operable, when a user touches the panel with a ball of high/her finger, to detect a contact point having a certain contact area depending on a device configuration of the panel. In this case, the contact-point acquisition section 301 may be configured to calculate a gravity center point of the area in the form of a coordinate of the contact point.

A multi-touch determination section 302 is operable to determine whether a contact with respect to the multi-touch input panel is a single touch (single point) or a multi-touch (multiple points). In the above panel device where a contact point to be detected when a user touches the panel with a ball of high/her finger has a certain contact area, the multi-touch determination section 302 is operable to determine whether the contact point is a single touch (single point) or a multi-touch (multiple points), based on a calculation result of a gravity center point of each area.

A touch-motion determination section 303 is operable, with respect to each of one or more (single touch or multi-touch) contact points determined by the multi-touch determination section 302, to track a moving motion of the contact point after being acquired by the contact-point acquisition section 301, and determine a touch motion (touch gesture) based on a resulting locus. For example, when a user touches with a single one of his/her fingers, a contact position of the finger is stored in the form of a coordinate. Then, when the user slidingly moves the finger in one of upward, downward, rightward and leftward directions while maintaining the contact with the panel, respective touch positions at intervals of a unit time are recorded in the form of a coordinate, and managed as a locus of a touch motion together with the initial touch (contact) position coordinate. Further, a distance between the initial contact position and a current touch position is measured at each of the unit time intervals, and, when the distance becomes greater than a given threshold value, this fact is notified to a page-number setting section 304.

When the fact that a touch motion over a distance greater than a given threshold value occurs is notified from the touch-motion determination section 303, the page-number setting section 304 is operable to set a turning-page number (the number of pages to be turned) for a page turning processing according to the determined touch motion. A process for the setting will be described in detail later. After the turning-page number is set by the page-number setting section 304, the turning-page number is notified to a page turning processing section 305.

The page turning processing section 305 is operable to execute a page turning operation based on the turning-page number notified from the page-number setting section 304. Details of the page turning processing section 305 will be described in detail later.

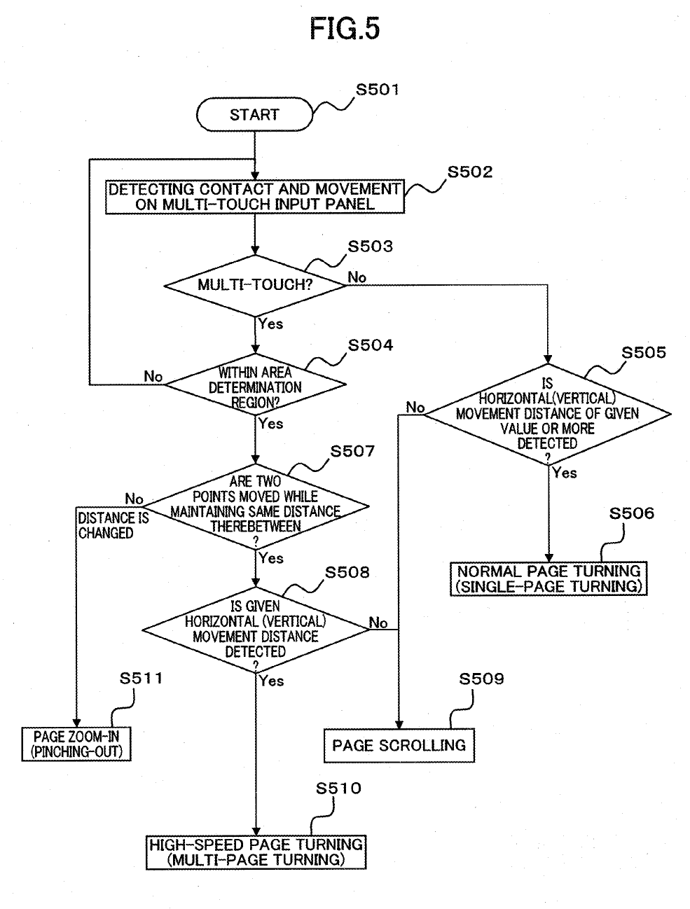

Based on the flowcharts illustrated in FIGS. 4 and 5, an operation of the information display apparatus according to this embodiment will be described below.

FIG. 4 is a schematic flowchart mainly illustrating an operation to be performed when a multi-touch input is made on the multi-touch input panel. A major feature of the information display apparatus according to the present invention is in that, when a touch input is performed using a plurality of pens or fingers, a processing of turning a plurality of pages at once (multi-page turning processing) is executed. Differently, a processing to be executed when a touch input is not performed using a plurality of pens or fingers, has many variations. For example, as illustrated in FIG. 4, the process may be configured such that, in such a situation, any page turning processing, particularly the multi-page turning processing, is not executed (NO in Step S 403). Alternatively, the process may be configured such that, when a touch input is performed using a single pen or finger, a processing of turning only a single page (single-page turning processing) is executed, as described later. Further, the process may be configured such, when a touch input is performed using a single pen or finger, and a sliding motion is performed over a distance equal to (or less than) a given value (while maintaining the touch), the motion is interpreted as an instruction for a page (screen) scrolling processing, and the screen scrolling processing is executed.

In this respect, FIG. 4 can be said to be a flowchart schematically illustrating the multi-page turning processing.

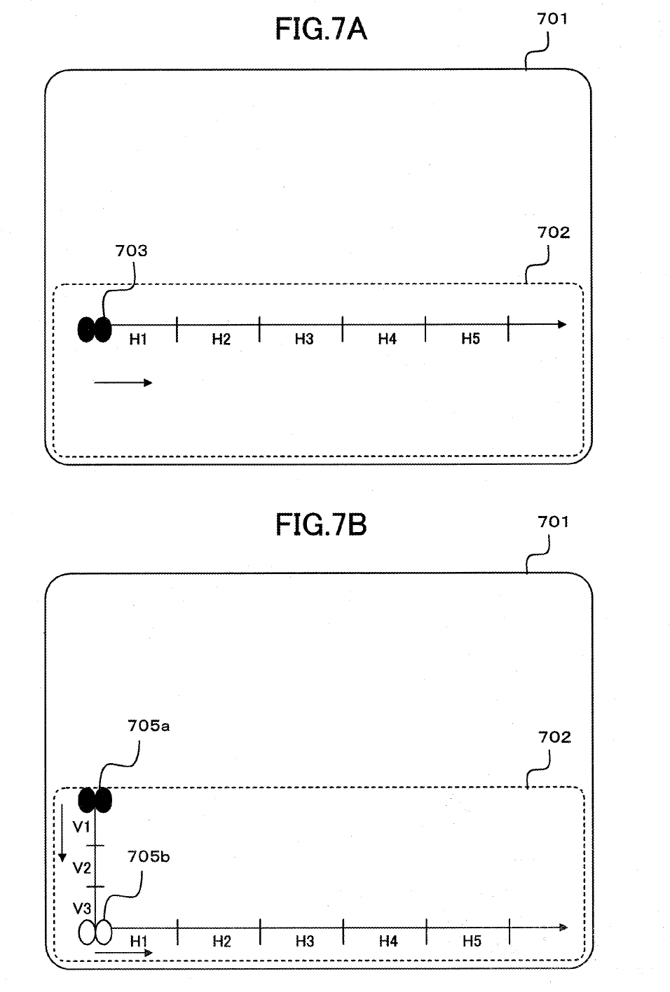

The process started at Step S401 advances to Step S402. In Step S402, a contact point with respect to the multi-touch input panel is detected. This processing is performed in the contact-point acquisition section 301. When a contact (input) with respect to the multi-touch input panel is detected, the process advances to Step S403. In Step S403, it is determined whether the contact is an instruction for the multi-page turning processing. This processing is performed under cooperation between the multi-touch determination section 302 and the touch-motion determination section 303. For example, in the present invention, as a prerequisite to performing the multi-page turning processing, it is necessary that there are at least two contacts (inputs) with respect to the multi-touch input panel. Thus, the multi-touch determination section 302 determines whether a contact is a single touch (single contact point) or a multi-touch (multiple contact points), and then the touch-motion determination section 303 determines a contact motion in each contact point (e.g., how much the contact point is slidingly moved). A specific example of this operation will be described with reference to FIG. 7(A). Firstly, when two contact points 703 are brought into contact with the multi-touch input panel 701, the position in FIG. 7(A) is detected as a coordinate. Then, along with a movement of the contact points 703 (in a rightward direction in FIG. 7(A)), a distance from the initial position is sequentially calculated. In this operation, a movement distance may be divided into several segments (e.g., in FIG. 7(A), H1, H2, H3, H4 and H5), to monitor in which of the segments the contact points 703 being slidingly moves are located.

Then, for example, when the contact is released (the pens or fingers are pulled away from the panel) after the contact points are slidingly moved by a given distance or more, the motion is interpreted as an instruction for the multi-page turning processing (YES in Step S403).

A direction of the page turning may be set to conform to a direction of the sliding movement. For example, in a horizontally-written electronic book, a rightward sliding motion may represent an instruction for increasing the turning-page number. In a vertically-written electronic book, a leftward sliding motion may represent an instruction for increasing the turning-page number.

It is understood that any other combination may be employed depending on configurations or specifications of electronic books.

When the motion is interpreted as an instruction for the multi-page turning processing, the process advances to Step S404. In Step S404, a turning-page number is calculated. This calculation may be performed according to a movement distance of a contact point with respect to the panel, as mentioned above. For example, a relationship between the sliding movement distance and the turning-page number may be set as follows: In the example illustrated in FIG. 7(A), the turning-page number is set to 2 pages, 4 pages and 6 pages when the sliding movement distance falls within the segment H1, the segment H2 and the segment H3, respectively. In this case, the relationship between the segment of the movement distance and the turning-page amount (number) is as illustrated in the following Table 1.

TABLE 1

| Segment of movement distance | Turning-page amount (number) |
|---|---|
| H1 | 2 |
| H2 | 4 |
| H3 | 6 |
| H4 | 8 |
| H5 | 10 |

In the Table 1, the number of segments H1 to H5 may be changed. Further, respective lengths of the segments H1 to H5 may be set to become equal to each other, or may be set to become different from each other. For example, when respective lengths of the segments H1 to H5 are set to become different from each other, they may be set to satisfy the following relation: H1<H2<H3<H4<H5. Further, the turning-page amount may be gradually increased from 2 pages by 2 pages according to the segments, as in the Table 1, or may be set to become multiples of 2, i.e., 2, 4, 8, 16, 32.

Table 1 illustrates one example of the turning-page amount (number) to be equally set when a plurality of fingers are moved. Alternatively, the turning-page amount may be changed between when two fingers are moved and when three fingers are moved. Typically, when two fingers are moved within the minimum movement distance segment (H1), the turning-page amount may be set to 2 pages, and three fingers are moved within the minimum movement distance segment (H1), the turning-page amount may be set to 3 pages. In this case, the relationship between the segment of the movement distance and the turning-page amount is as illustrated in the following Table 2.

TABLE 2

| Segment of movement distance | Turning-page amount (number) |
|---|---|
| H1 | f |
| H2 | 2f |
| H3 | 3f |
| H4 | 4f |
| H5 | 5f |

In the Table 2, f is the number of effective contact points (fingers) with respect to the screen.

Alternatively, as in the following Table 3, the movement within the first segment H1 may be assigned to other processing (e.g., scrolling processing) without being determined as an instruction for the multi-page turning processing.

TABLE 3

| Segment of movement distance | Turning-page amount (number) |
|---|---|
| H1 | Scrolling according to distance |
| H2 | Page turning (p pages) |
| H3 | Page turning (q pages) |
| H4 | Page turning (r pages) |
| H5 | Page turning (s pages) |

In the Table 3, p<q<r<s.

Further, the turning-page amount in the Table 3 may be set to become proportionate to the number f of effective contact points (fingers) with respect to the screen. For example, the turning-page amount may be assigned as illustrated in the following Table 4.

TABLE 4

| Segment of movement distance | Turning page mount (number) |
|---|---|
| H1 | Scrolling according to distance |
| H2 | Page turning (p f pages) |
| H3 | Page turning (q f pages) |
| H4 | Page turning (r f pages) |
| H5 | Page turning (s f pages) |

When the turning-page number is calculated, the process advances to Step S405. In Step S405, a page turning processing is performed, and the process is terminated (Step S406). The process illustrated in FIG. 4 is configured such that, in Step S403, when it is determined that the motion is not an instruction for the multi-page turning processing, the process is immediately terminated. Alternatively, the process may be configured such that, when there is an instruction for a single-page turning processing, a processing for turning only one page is executed, as mentioned above.

The flowchart illustrated in FIG. 5 includes a function of speeding up the determination on an instruction for the multi-page turning processing. Specifically, when a multi-contact is made in a predetermined region 702 (e.g., a lower region of the panel) as illustrated in FIG. 7(A), the motion is determined as an instruction for the multi-page turning processing, which makes it possible to facilitate speeding-up of the determination. This means that, even if a multi-contact is detected a remaining region other than the region 702, the determination on the movement distance or the touch motion is not performed.

On the other hand, when a contact with respect to the panel is not a multi-contact (multi-touch), a processing other than the multi-page turning processing is assigned, for example, even if the contact is a single touch, to enhance operability for an electronic book reader. Further, after the motion is determined as an instruction for the multi-page turning processing, a measurement of the movement distance is performed while allowing the instruction for the multi-page turning processing to be distinguished from other instructions (commands) (such as pinching-in/pinching-out) using a multi-touch.

The process starts at Step S501 and advances to Step S502. In Step S502, a contact and a movement on the multi-touch input panel are detected. These processings are performed in the contact-point acquisition section 301 and the touch-motion determination section 303. Then, the process advances to Step S503, it is determined whether the contact detected in Step S502 is a multi-touch.

When it is determined that the contact is not a multi-touch, it is determined that the contact is a single touch, and the process advances to Step S505. In Step S505, it is determined whether a horizontal (vertical) movement distance of a given value or more is detected. If YES in Step S505, the process advances to Step S506. In Step S506, a single-page turning processing is executed. If NO in Step S505, the motion is determined as an instruction for a page (screen) scrolling processing, and the scrolling processing is executed according to the movement distance (Step S509).

When the contact is determined as a multi-touch in Step S503, the process advances to Step S504. In Step S504, it is determined whether the contact points are located within a predetermined region (within an area determination region). The purpose and content of the processing in Step S504 are as already described above. If NO in Step S504, the process returns to Step S502. If YES in Step S504, the process advances to Step S507. In Step S507, it is determined whether the plurality of contacts (e.g., two points) are moved while maintaining the same distance therebetween. If the distance between the contacts is changed (e.g., increased) (NO in Step S507), the motion is interpreted as a pinching-out operation and a page (screen) zoom-in processing is performed (Step S511).

If YES in Step S507, the process advances to Step S508. In Step S508, when a given horizontal (vertical) movement distance is detected and calculated (YES in Step S508), the process advances to Step S510. In Step S510, the multi-page turning processing is performed according to the movement distance. On the other hand, if the contact is released without detection of the given horizontal (vertical) movement distance (NO in Step S508), the process advances to Step S509. In Step S509, the motion is determined as an instruction for a page (screen) scrolling processing, and the scrolling processing is executed according to the movement distance.

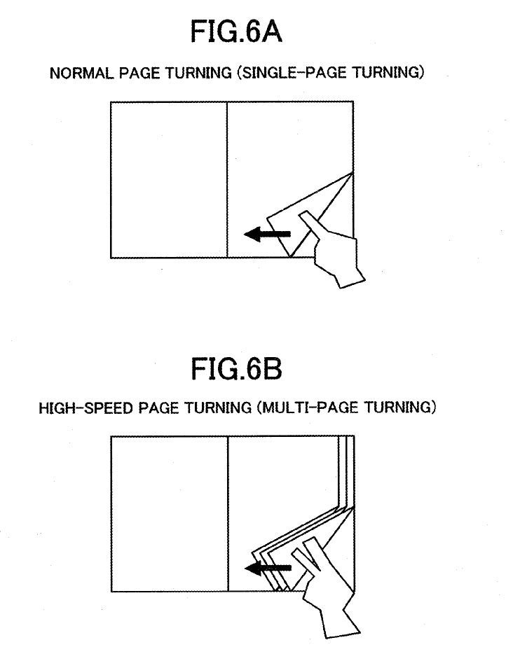

FIGS. 6(A) and 6(B) are schematic diagrams illustrating a page turning motion (gesture) on a screen, wherein FIG. 6(A) illustrates a single-page turning motion, and FIG. 6(A) illustrates a multi-page turning motion.

In FIG. 6(A), when a single touch is slidingly moved on a screen, after a sliding movement of a given distance is detected, a single-page turning processing is performed in a direction of the sliding movement. In FIG. 6(B), when a multi-touch is slidingly moved on the screen, after a sliding movement of a given distance is detected, a turning-page number is calculated according to the distance, and a multi-page turning processing is performed in a direction of the sliding movement. As illustrated in FIGS. 6(A) and 6(B), it is more preferable to perform an image processing for presenting an image indicative of a page having a folded portion on a lower right side thereof to allow a user to recognize a state when the page is actually turned.

FIGS. 7(A) and 7(B) are schematic diagrams illustrating a relationship between a distance and a turning-page number during sliding movement of a contact position. FIG. 7(A) has already described. FIG. 7(B) illustrates another example different from that in FIG. 7(A).

FIG. 7(B) shows that, when a touch movement on a screen is performed along two axes, a multi-page turning motion can be efficiently performed. Specifically, in FIG. 7(B), fingers or pens 705a touching the screen are slidingly moved along the vertical axis by a given distance to reach a position 705b, and then slidingly moved from the position 705b along the horizontal axis by a given distance, so that it becomes possible to extract the page-turning amount (number) from a larger distance range. More specifically, movement distance segments V1, V2, V3 are assigned to the vertical axis, and movement distance segments H1, H2, H3, H4, H5 are assigned to the horizontal axis. Then, three multiple values, such as ×1 (1 time), ×2 (2 times) and ×3 (3 times), are assigned to respective ones of the segments V1, V2, V3, and five page numbers are assigned to respective ones of the segments H1 to H5, for example, to satisfy the following relation: page number for H1<page number for H2<page number for H3<page number for H4<page number for H5.

In this case, when a sliding movement of the fingers or pens is started on the vertical axis, and shifted at a position within the segment V1, from the vertical direction toward the horizontal direction, a page number 1 time the page number assigned to the segment on the horizontal axis in which the fingers or pens are finally located, is set as the turning-page number.

Differently, when the sliding movement of the fingers or pens is started on the vertical axis, and shifted at a position within the segment V2, from the vertical direction toward the horizontal direction, a page number 2 time the page number assigned to the segment on the horizontal axis in which the fingers or pens are finally located, is set as the turning-page number.

Further, when the sliding movement of the fingers or pens is started on the vertical axis, and shifted at a position within the segment V3, from the vertical direction toward the horizontal direction, a page number 3 time the page number assigned to the segment on the horizontal axis in which the fingers or pens are finally located, is set as the turning-page number.

As above, two kinds of information may be assigned to two axes, respectively. This makes it possible to provide desired operationality even in a situation where, in an e-book having an extremely large number of pages, it is necessary to frequently access to all of the pages.

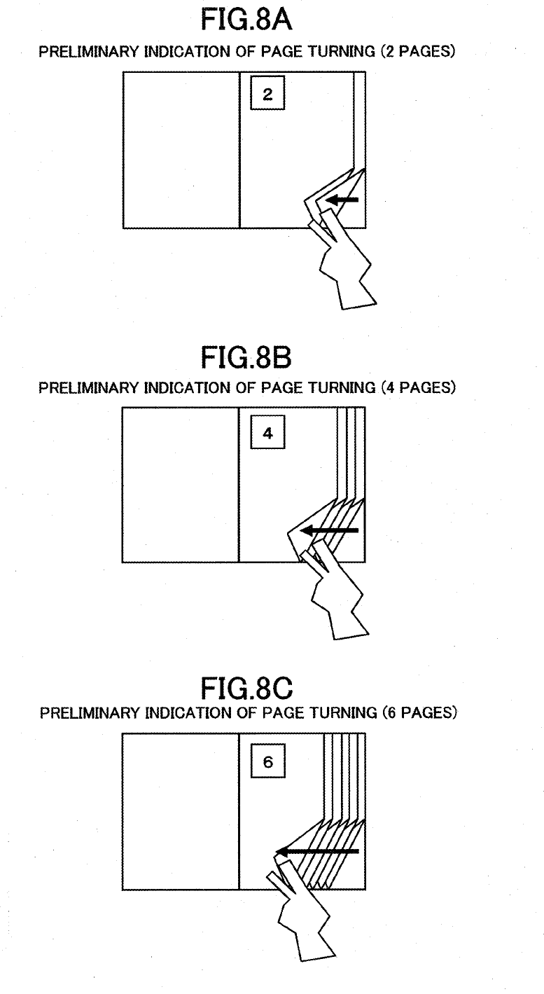

FIGS. 8(A) to 8(C) are schematic diagrams illustrating an example in which a turning-page number is preliminarily displayed according to a sliding distance in real time. FIGS. 8(A) to 8(C) illustrate a series of multi-page turning motions. Firstly, in FIG. 8(A), in the situation where the given sliding movement distance is detected, and the motion is determined as an instruction for the multi-page turning processing, when the fingers are located at a position within the initial movement segment, a turning-page number to be set when the contact is released at the position is indicated by a numeral “2” and “two folded portions” of image-processed pages on a lower right side of a screen. Then, when the fingers are continuously slidingly moved to a position within the next movement segment (FIG. 8(B)), a turning-page number to be set when the contact is released at the position is indicated by a numeral “4” and “four folded portions” of image-processed pages on the lower right side of the screen. Then, when the fingers are further continuously slidingly moved to a position within the next movement segment (FIG. 8(C)), a turning-page number to be set when the contact is released at the position is indicated by a numeral “6” and “six folded portions” of image-processed pages on the lower right side of the screen. Only one of the numeral-based indication and the image-based indication may be selectively used.

Such a visual processing may be performed in real time in the above manner. This becomes it possible to provide further desirable operability to a user.

Although FIGS. 7(A) to 7(C) illustrate a technique of, when multiple contacts are made in a predetermined region 702 (e.g., a lower region of the panel), determining that the input is an instruction for the multi-page turning processing, the present invention is not limited thereto. For example, in a situation where there are multiple contacts over the entire region of the screen, it is possible to determine to which of the contacts an instruction for the multi-page turning processing corresponds and which of the contacts is noise (e.g., caused by fingers which are just placed on the screen). Specifically, the following determination technique may be employed.

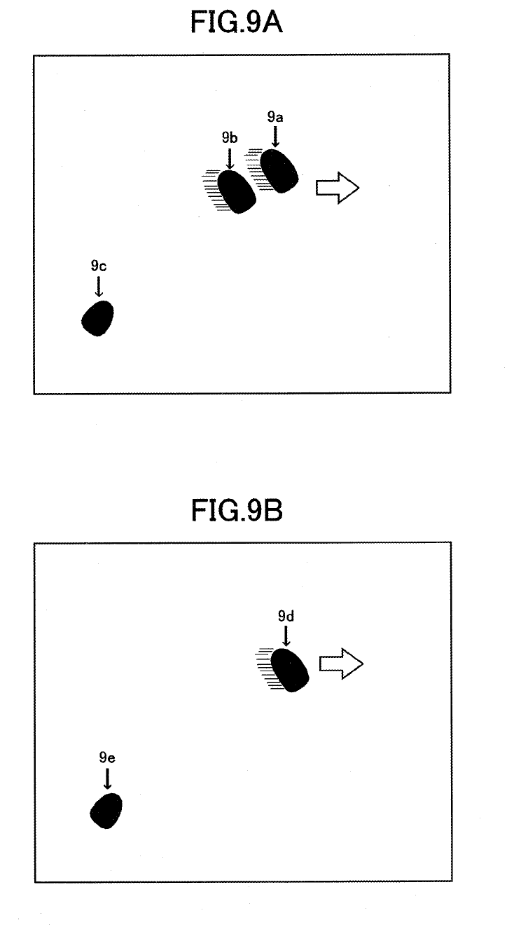

For example, in FIG. 9(A), there are three contacts 9a, 9b, 9c in the entire region. This example will be described on an assumption that the contacts 9a, 9b are intended to enter an instruction for the multi-page turning processing by two fingers, and the contact 9c is caused by a thumb or other finger which is just placed on the screen).

When there are two or more contact points within the entire region a retention time of each of the contact points is counted so as to determine whether the contact point is not moved or whether the contact point is moved over a distance of less than a given threshold value. Then, one (9c in FIG. 9(A)) of the contact points having a retention time of a given time or more is determined as noise, and the remaining contact points (9a, 9b in FIG. 9(A)) are determined as an instruction for a page turning processing.

When the contact points 9a, 9b are moved while maintaining the same distance therebetween (or while maintaining a distance therebetween at a given value or less), the motion is determined as an instruction for the multi-page turning processing, and the multi-page turning processing is executed. Differently, when the contact points 9a, 9b are moved while changing a distance therebetween (or under a condition that the distance is changed by a given value or more per unit time), the motion is determined as an instruction for a pinching-in/pinching-out processing. If the contact point 9c is moved after it is determined to be not an instruction, a count of the retention time is reset.

In FIG. 9(B), there are two contacts 9d, 9e in the entire region. This example will be described on an assumption that the contact 9d is intentionally slidingly moved without moving the contact 9e. In this case, the point 9e has a retention time of a given value or more. Thus, even if the contact 9d is slidingly moved, this motion is not interpreted as pinching-out, so that the same processing as that for the single-touch is executed.

In the example illustrated in FIG. 9(B), if the point 9d is moved before an elapse of a given time after the point 9e is placed on the screen, the motion is likely to be determined as pinching-out. In order to properly interpret a user's instruction even in the above situation, the following processing algorithm may be employed.
(1) When there are a plurality of contact points on the screen, a moving one or more of the contact points are monitored.
(2) When two or more of the contact points are moved while maintaining the same distance therebetween, the multi-page turning processing is executed.
(3) When two or more of the contact points are moved while changing a distance therebetween, a pinching-in/pinching-out processing is executed.
(4) When only one of the contact points is moved, a normal page-turning processing for a single touch is executed.

Although the information display apparatus of the present invention has been described based on a specific embodiment thereof, the present invention is not limited to a single unit as in the specific embodiment, but may be a system comprising a plurality of separate units. Further, the present invention may be implemented in the form of as a method, a program or a recording medium recording the program (e.g., optical disk, magneto optical disk, CD-ROM, CD-R, CD-RW, magnetic tape, hard disk or memory card), etc.

As a form of implementation, the program is not limited to an application program, such as an object code compiled by a compiler, or a program code executable by an interpreter, but may be a program module to be incorporated in an operating system.

As a technique for providing the program according to the present invention to an information display apparatus, it is possible to access a site on the Internet using a browser installed in a client computer, and download a computer program implementing the information display method of the present invention from the site via a network.

Further, the program is not necessarily entirely implemented in a CPU on a main board of a computer, but may be entirely or partly implemented in a CPU or a DSP in an extension board or an extension unit added to the computer.

### EXPLANATION OF CODES

100: information display apparatus
101: housing
102: display
201: input section
202: storage section
203: central processing section
204: display section
205: control section
206: communication interface section
207: output section
208: timekeeping section
209: sensor section
210: power supply section
211: connection line (bus)

1. An information display apparatus for performing control based on a plurality of touch inputs from a multi-touch input panel, comprising:
a contact-point acquisition section for acquiring a contact point on the multi-touch input panel;
a multi-touch determination section for determining whether the contact point acquired by the contact-point acquisition section is a multi-touch;
a touch-motion determination section for, when the contact point is determined as a multi-touch by the multi-touch determination section, determining a moving motion of the contact point;
a page-number setting section for calculating and setting a turning-page number for a multi-page turning processing, based on the moving motion determined by the touch-motion determination section; and
a page turning processing section for performing a page turning processing based on the turning-page number determined by the page-number setting section,
wherein the page-number setting section is adapted to manage a distance during the contact-point moving motion, based on a plurality of segments for each of two moving motions in two directions, the page-number setting section being operable to calculate the turning-page number by multiplication between each of a plurality of multiple values assigned correspondingly to respective ones of the segments for the moving motion in one of the two directions, and a respective one of a plurality of page numbers assigned correspondingly to respective ones of the segments for the moving motion in the other direction.

2. The information display apparatus as defined in claim 1, wherein the touch-motion determination section is operable, when it is detected that the contact-point moving motion is performed over a distance of a given value or more, to determine that the contact-point moving motion is valid.

3. The information display apparatus as defined in claim 1, wherein: the multi-touch determination section is operable, when it determines that the contact point is not a multi-touch, to determine that the contact point is a single touch; and the touch-motion determination section is operable, when it is detected that the contact-point moving motion is performed over a distance of a given value or more, to determine that the contact-point moving motion is valid, and wherein the page turning processing section is operable, in response to the determination by the touch-motion determination section, to execute a single-page turning processing.

4. The information display apparatus as defined in claim 1, wherein the multi-touch determination section is operable to determine that only a multi-touch performed within a predetermined region on the multi-touch input panel is a valid instruction for the multi-page turning processing.

5. The information display apparatus as defined in claim 1, wherein the touch-motion determination section is operable, when it is detected that the contact-point moving motion is performed over a distance of less than a given value, to determine that the motion is an instruction for a screen scrolling processing.

6. The information display apparatus as defined in claim 1, wherein the touch-motion determination section is operable, when there are two or more contact points within an entire region of a screen of the multi-touch input panel, to count a retention time of each of the contact points so as to determine whether the contact point is not moved or whether the contact point is moved over a distance of less than a given threshold value, and wherein the touch-motion determination section is operable to determine at least one of the contact points having a retention time of a given time or more, as noise, and determine the remaining contact points, as an instruction for a page turning processing.

7. The information display apparatus as defined in claim 1, wherein the touch-motion determination section is operable, (1) when there are a plurality of contact points on a screen of the multi-touch input panel, to monitor a moving one or more of the contact points, and wherein the touch-motion determination section is operable; (2) when two or more of the contact points are moved while maintaining a same distance therebetween, to determine that the motion is an instruction for the multi-page turning processing; or (3) when two or more of the contact points are moved while changing a distance therebetween, to determine that the motion is an instruction for a pinching-in/pinching-out processing; or (4) when only one of the contact points is moved, to determine that the contact point is a single touch.

8. The information display apparatus as defined in claim 1, wherein the touch-motion determination section is operable, when there are two or more contact points within an entire region of a screen of the multi-touch input panel, to count a retention time of each of the contact points so as to determine whether the contact point is not moved or whether the contact point is moved over a distance of less than a given threshold value, and wherein the touch-motion determination section is operable to determine at least one of the contact points having a retention time of a given time or more, as noise, and determine the remaining contact points as an instruction for a page turning processing, the touch-motion determination section being operable, (1) when there are a plurality of contact points on the screen, to monitor a moving one or more of the contact points, and wherein the touch-motion determination section is operable; (2) when two or more of the contact points are moved while maintaining a same distance therebetween, to determine that the motion is an instruction for the multi-page turning processing; or (3) when two or more of the contact points are moved while changing a distance therebetween, to determine that the motion is an instruction for a pinching-in/pinching-out processing; or (4) when only one of the contact points is moved, to determine that the contact point is a single touch.

9. An information display program executable in an information display apparatus for performing control based on a plurality of touch inputs from a multi-touch input panel, the information display program being adapted to cause the information display apparatus to perform a process comprising the steps:
a contact-point acquisition step of acquiring a contact point on the multi-touch input panel;
a multi-touch determination step of determining whether the contact point acquired through the contact-point acquisition step is a multi-touch;
a touch-motion determination step of, when the contact point is determined as a multi-touch through the multi-touch determination step, determining a moving motion of the contact point;
a page-number setting step of calculating and setting a turning-page number for a multi-page turning processing, based on the moving motion determined through the touch-motion determination step; and
a page turning processing step of performing a page turning processing based on the turning-page number determined through the page-number setting step,
wherein the page-number setting step includes: managing a distance during the contact-point moving motion, based on a plurality of segments for each of two moving motions in two directions; and calculating the turning-page number by multiplication between each of a plurality of multiple values assigned correspondingly to respective ones of the segments for the moving motion in one of the two directions, and a respective one of a plurality of page numbers assigned correspondingly to respective ones of the segments for the moving motion in the other direction.
